(19) United States
(12) Patent Application Publication
(10) Pub. No.: US 2010/0003436 A1
(43) Pub. Date: Jan. 7, 2010

(54) Threads, Fibers and Filaments for Weaving Without Sizing

(76) Inventors: Cécile Lopez, Saint Marcel Bel Accueil (FR); Bertrand Bordes, Lyon (FR); Christian Wattenhofen, Buonas (CH)

Correspondence Address: LADAS & PARRY LLP, 26 WEST 61ST STREET, NEW YORK, NY, 10023, US

(21) Appl. No.: 12/085,842

(22) PCT Filed: Dec. 5, 2006
(86) PCT No.: PCT/EP2006/069299

§ 371 Date: Aug. 26, 2009

(30) Foreign Application Priority Data
Dec. 6, 2005 (FR) 05/12347

(51) Int. Cl. B32B 1/02; B29C 59/00; D02G 3/36; D03D 15/00; D04B 21/14; D03D 1/00

(52) U.S. Cl. 428/36.1; 264/129; 428/378; 264/134; 442/187; 442/307; 524/588; 106/287.1; 139/420 R

(57) ABSTRACT

The invention relates to a sizing composition for threads, fibres and filaments. More specifically, the invention relates to threads, fibres and filaments which can be woven using a method that does not involve sizing or a washing step and which have the aforementioned composition on at least part of the surface thereof. The invention also relates to a method of preparing the aforementioned threads, fibres and filaments. The invention further relates to fabrics that are produced from said threads, fibres and filaments, using a method that does not involve sizing or a washing step, such as with a dry loom. In addition, the invention relates to the use of said threads, fibres and filaments and the resulting woven or knit fabrics for safety air bags.

The invention relates to a finish composition for yarns, fibers or filaments. The invention relates more particularly to yarns, fibers and filaments that can be woven with neither sizing nor a washing step, having this composition present on at least part of their surface, and also to a process for producing yarns, fibers and filaments. It also relates to wovens obtained, with neither a sizing step nor a washing step, from these yarns, fibers and filaments and to a process for weaving without sizing and without a washing step, using these yarns, fibers and filaments, especially using a dry loom. Finally, the invention relates to the use of yarns, fibers and filaments and to wovens and knits in the airbag field.

To ensure cohesion of the yarns intended for weaving, it is general practice to carry out a twisting operation on them. However, this twisting operation is being replaced more and more by a pneumatic process for interlacing the filaments. Thus, depending on the pressure of the fluid and the interlacement means, the number of points of cohesion, i.e. the number of points at which the filaments form a node, may be varied according to the desired final appearance of the yarn and its subsequent use.

To make it easier for the fibers and yarns to slip over one another, it is common practice to apply oils or finish products. As regards continuous artificial and synthetic yarns, these oils or finishes are applied to the yarn one or more times during its production process. These oils or finish products are generally removed after weaving by treating the woven during a washing operation. The presence of the these oils or finish products can effectively be deleterious, in particular in the field of airbags. For example, they may reduce the level of adhesion of the woven to the protective coating and also the fire resistance and temperature resistance properties of the airbags.

During the use of warp yarns, mainly in weaving, it is known that they rub, on the one hand, against one another owing to the ascending and descending movement of the heddle shafts and, on the other hand, against the components of the loom such as heddle eyes through which they pass, reed dents, sley, unwinder, warp stop motion, etc. To prevent the rubbing from causing defects prejudicial to the actual weaving operation and to the quality of the woven fabric produced, a prior treatment called sizing is carried out on the yarn. This treatment, well known for being applied on spun fiber yarns to ensure cohesion of the fibers and form a protective sheath on the spun yarn, is also applied on artificial and synthetic multifilament continuous yarns. The sizing operation must ensure that the filaments, being generally of low linear density and thus fragile, are held in place and protected and must surround the continuous yarns with a sheath for preventing the rubbing described above and for consequently making it easier for them to slip both on the components of the loom and between filaments, for the purpose of producing woven fabrics without any visual defect and preventing, as far as possible, breakages and fraying. These sizing products are generally removed after weaving by treating the woven fabric during the desizing operation. The desizing operation also makes it possible to remove oils and finish products present on the yarns; in this case the abovementioned washing operation is carried out during the desizing operation.

To save on the cost of sizing and desizing operations and thus to eliminate two yarn-handling operations, it has been sought to dispense with the sizing operation, which is moreover harmful to the environment. Furthermore, the sizing product may prove difficult to completely remove, depending on the type of product used, the type of yarn and the weave of the fabric, thereby running the risk of sizing residues being present in the woven fabric. The presence of these residues may prove to be deleterious, in particular in the field of airbags; for example, their presence may degrade the performance of the product upon aging and also its fire and temperature resistance properties.

It has therefore being sought to eliminate the sizing operation and the washing operation in the manufacture of fabrics for bags for the individual protection of vehicle passengers, also called “airbags”. The elimination of this sizing step and washing step must however not impair but maintain the required properties of the fabric in its use as an airbag.

There are two types of base woven fabrics for airbags: fabrics having a protective coating layer made of an elastomer, for example a silicone resin, and fabrics that do not have a protective coating layer made of elastomer, especially for weight reasons.

Historically, as regards woven fabrics having a protective coating, the airbags are formed by a cloth of synthetic fiber, for example a polyamide (Nylon®) covered on at least one of its faces with a layer of an elastomer of the chloroprene type. The airbag (or inflatable cushion) is made of a tightly woven and folded polyamide fabric. The presence of such a layer or such a protective coating is dictated by the fact that the gases released by the gas generator (for example carbon monoxide, NOx) in the event of an impact are extremely hot and contain incandescent particles liable to damage the Nylon® airbag.

Silicone protective coatings are also used. These are generally obtained by coating the substrate followed by curing, taking place by the polyaddition of unsaturated (alkenyl, e.g. Si—Vi) groups of a polyorganosiloxane on hydrogens of the same or another polyorganosiloxane.

The internal protective layer made of elastomer and the support made of synthetic fabric forming the walls of the airbag must in particular be perfectly adherent and withstand the high temperature and mechanical stresses. The airbags must in particular exhibit good fire resistance and temperature resistance properties and also good rubbing and abrasion resistance (scrub test).

It is therefore sought, in particular for airbags having a protective coating, to eliminate the sizing operation and the washing operation during manufacture of the fabrics, while still maintaining or even improving the properties of the fabric that are required for its application as an airbag, especially the fire and temperature resistance properties and rubbing and abrasion resistance properties (scrub test).

For this purpose, the present invention provides, in a first object, a finish composition for yarns, fibers or filaments, which in particular allows weaving without sizing and without washing.

In a second object, the invention provides yarns, fibers or filaments that can be woven without sizing and without washing, the finish composition being present on at least part of the surface of the yarns, fibers or filaments, and also a process for producing these yarns, fibers or filaments.

The invention provides, in a third object, a woven or knitted fabric obtained in particular from these yarns, fibers or filaments, and also to a process for obtaining this woven or knitted fabric.

The invention provides, in a fourth object, the use of these yarns, fibers, filaments, woven and knitted fabrics in the field of airbags.

Finally, in a fifth object, the invention provides an airbag woven or knitted fabric produced from yarns, fibers or filaments having a composition comprising a polyorganosiloxane on the surface of these yarns, fibers or filaments, and also a process for obtaining this woven or knitted fabric.

The invention therefore relates, in a first object, to a finish composition for yarns, fibers or filaments, comprising a compound A and/or a compound B, compound A being a monomer, an oligomer and/or a polymer containing at least one Si—H structural unit and compound B being a monomer, an oligomer and/or a polymer containing at least one unsaturated aliphatic group. A finish composition, applied to yarns, fibers or filaments during their production process, makes it easier for them to slide. The finish composition of the invention, applied to yarns, fibers or filaments, allows not only good behavior during the spinning, warping and size-free operations without sizing, but also a fabric to be obtained that has good final properties, particularly in the case of a woven airbag fabric having a protective silicon coating. The fabric has in particular good properties in terms of rubbing and abrasion resistance (scrub test) and fire and temperature resistance properties, without it being necessary to remove the finish composition present on the surface of the yarns, fibers or filaments of the fabric.

According to one particular embodiment of the finish composition of the invention, the polyorganosiloxane A is a polyorganohydrogenosiloxane comprising:
units of the following formula:

$${H}_{a} {W}_{b } {SiO}_{\frac{4 - ( a + b )}{2}} \qquad ( 1 )$$

in which:
the symbols W are equal and/or different and represent:
   a linear or branched alkyl residue containing 1 to 18 carbon atoms, optionally substituted with at least one halogen,
   a cycloalkyl residue containing 5 to 8 ring carbon atoms, optionally substituted with at least one halogen,
   an aryl residue containing 6 to 12 carbon atoms which may optionally be substituted on the aryl part with at least one halogen atom, or an alkyl and/or alkoxyl group containing 1 to 3 carbon atoms,
   an arylalkyl part having an alkyl part containing 5 to 14 carbon atoms and an aryl part containing 6 to 12 carbon atoms, optionally substituted on the aryl part by at least one halogen atom, or an alkyl and/or alkoxyl group containing 1 to 3 carbon atoms,
   a is 1 or 2, b is 0, 1 or 2, with the sum (a+b) having a value of 1 to 3; and
optionally, other units of average formula (2):

$$Wc {SiO}_{\frac{4 - c}{2}} \qquad ( 2 )$$

in which W has the same meaning as above and c has a value of 0 to 3.

The polyorganosiloxane A may be formed only from units of formula (1) or may also include units of formula (2).

It may have a linear, branched or unbranched, cyclic or crosslinked structure. The degree of polymerization is equal to or greater than 2. More generally, it is less than 5000.

Examples of units of formula (1) are

### H(CH₃)SiO_{1/2}, HCH₃SiO_{2/2}, H(C₆H₅)SiO_{2/2}.

When linear polymers are involved, these essentially consist of “D” units, namely W₂SiO_{2/2} and WHSiO_{2/2}, and “M” units, namely W₃SiO_{1/2} and WH₂SiO_{1/2}, it being possible for the blocking terminal “M” units to be trialkylsiloxy or dialkylarylsiloxy groups.

As examples of terminal “M” units, mention may be made of trimethylsiloxy, dimethylphenylsiloxy, dimethylethoxysiloxy, dimethylethyltriethoxysilylsiloxy groups.

As examples of “D” units, mention may be made of dimethylsiloxy and methylphenylsiloxy groups.

These linear polyorganosiloxanes may be oils having a dynamic viscosity at 25° C. of the order of 1 to 100 000 mPa·s at 25° C., generally of the order of 10 to 5000 mPa·s at 25° C.

When cyclic polyorganosiloxanes are involved, these consist of W₂SiO_{2/2}, WHSiO_{2/2} “D” units, which may be of the dialkylsiloxy or alkylarylsiloxy type. They have a viscosity of the order of 1 to 1000 mPa·s.

The dynamic viscosity at 25° C. of all the polyorganosiloxane polymers considered in the present disclosure may be measured using a BROOKFIELD viscometer according to the AFNOR NFT 76 102 standard of February 1972.

The polyorganosiloxane A is preferably chosen from:
polydimethylsiloxanes having hydrogenodimethylsilyl end groups;
polydimethylhydrogenomethylsiloxanes having trimethylsilyl end groups;
polydimethylhydrogenomethylsiloxanes having hydrogenodimethylsilyl end groups;
polyhydrogenomethylsiloxanes having trimethylsilyl end groups; and
cyclic polyhydrogenomethylsiloxanes.

Compound B of the finish composition of the invention is advantageously a polyorganosiloxane.

According to one particular embodiment of the finish composition of the invention, the polyorganosiloxane B is chosen from polyorganosiloxanes comprising equal or different units of formula (3):

$${W}_{d}^{′} {Y}_{e} {SiO}_{\frac{4 - ( d + e )}{2}} \qquad ( 3 )$$

in which:
the symbols W′, which are equal and/or different, represent:
   a linear or branched alkyl residue containing 1 to 18 carbon atoms, optionally substituted with at least one halogen,
   a cycloalkyl residue containing 5 to 8 ring carbon atoms, optionally substituted with at least one halogen,
   an aryl residue containing 6 to 12 carbon atoms which may optionally be substituted on the aryl part with at least one halogen atom, or an alkyl and/or alkoxyl group containing 1 to 3 carbon atoms,
   an arylalkyl part having an alkyl part containing 5 to 14 carbon atoms and an aryl part containing 6 to 12 carbon atoms, optionally substituted on the aryl part by at least one halogen atom, or an alkyl and/or alkoxyl group containing 1 to 3 carbon atoms,
the symbols Y are equal or different and represent a C₁-C₁₂ linear or branched alkenyl residue having at least one ethylenic unsaturation at the chain end and/or in the chain, and optionally at least one heteroatom;
e is equal to 1 or 2, d is equal to 0, 1 or 2 with the sum (d+e) having a value of 1 to 3;
optionally, other units of average formula (2′):

$${W}^{′} c {SiO}_{\frac{4 - c}{2}} \qquad ( {2}^{′} )$$

in which W′ has the same meaning as above and c has a value of 0 to 3.

With regard to the residues Y, these are advantageously chosen from the following list: vinyl, propenyl, 3-butenyl, 5-hexenyl, 9-decenyl, 10-undecenyl, 5,9-decadienyl and 6,11-dodecadienyl.

These polyorganosiloxanes may have a linear (branched or unbranched), cyclic or crosslinked structure. Their degree of polymerization is preferably from 2 to 5000.

When linear polymers are involved, these essentially consist of W′SiO_{2/2}, Y₂SiO_{2/2} and W′₂SiO_{2/2} “D” units, and W′YSiO_{1/2}, W′₂YSiO_{1/2} and W′₃SiO_{1/2} “M” units, it being possible for the blocking terminal “M” units to be trialkylsiloxy, dialkylarylsiloxy, dialkylvinylsiloxy or dialkylalkenylsiloxy groups.

Said linear polyorganosiloxanes may be oils having a viscosity at 25° C. of the order of 1 to 100 000 mPa·s at 25° C., generally of the order of 10 to 5000 mPa·s at 25° C.

When cyclic polyorganosiloxanes are involved, these consist of W′SiO_{2/2}, W′YSiO_{2/2} and W′₂SiO_{2/2} “D” units, which may be of the dialkylsiloxy, alkylarylsiloxy, alkylvinylsiloxy or alkylsiloxy type. Examples of such units have already been given above.

Said cyclic polyorganosiloxanes B may have a viscosity of the order of 1 to 5000 mPa·s.

Aliphatically unsaturated polyorganosiloxanes B useful within the context of the invention are, for example, olefinically or acetylenically unsaturated polyorganosiloxanes well known in the technical field in question. In this regard, the reader may refer to U.S. Pat. Nos. 3,159,662, 3,220,272 and 3 410 886 which describe the abovementioned compounds.

Advantageously, the finish composition of the invention does not contain a hydrosilylation catalyst.

The composition of the invention may include an antistatic agent. Preferably, the antistatic agent is a polyorganosiloxane. Advantageously, the antistatic agent is a polysiloxane/polyoxyalkylene copolymer characterized in that the copolymer comprises units of general formulae:

$$\begin{matrix}\begin{matrix}{R}_{a} {SiO}_{\frac{4 - a}{2}} ; \\ and & \end{matrix} & ( i ) \\ {R}_{b} {R}_{c}^{′} {SiO}_{\frac{4 - ( b + c )}{2}} , & ( ii )\end{matrix}$$

in which each R represents a monovalent hydrocarbon group, at least 80% of these groups being methyl groups, each R′ represents a substituting group of general formula Q(OA)ₙOZ where Q represents a divalent group attached to the silicon atom, A represents an alkylene group at least 80% of the OA groups being oxyethylene groups, and Z represents a hydrogen atom or an OCR″ group in which R″ represents a monovalent group, a has a value of 1, 2 or 3, b has a value of 0, 1 or 2, c has a value of 1 or 2, the sum of b and c is not greater than 3 and n has a value of 5 to 25, the copolymer having an average molecular formula such that the OA groups provide about 25% to about 65% by weight of the calculated molecular weight of the copolymer.

Polysiloxane/polyoxyalkylene copolymers that can be used in the invention comprise siloxane units of general formula:

$${R}_{a} {SiO}_{\frac{4 - a}{2}} \qquad ( i )$$

in which each R represents a monovalent hydrocarbon group. These units are present as chain units of the polysiloxane molecule and may also be present as terminal units of the polysiloxane molecule. Some of the R groups may be unsubstituted hydrocarbon groups, whether saturated, aliphatic or aromatic, but not less than 80% of these R groups are methyl groups, and particularly preferably each is a methyl group. The units of general formula (1) constitute more than half of the units of the polysiloxane molecule and may for example constitute from about 65% to about 92% of the units of the siloxane, in particular from about 78% to about 85% of these units.

The polysiloxane/polyoxyalkylene copolymers that can be used in the invention comprise siloxane units of general formula:

$${R}_{b} {R}_{c}^{′} {SiO}_{\frac{4 - ( b + c )}{2}} \qquad ( ii )$$

in which R represents a group as indicated above and R′ represents a group of general formula Q(OA)ₙOZ (i.e. a group containing oxyalkylene residues) in which A represents a divalent hydrocarbon group, at least 80% of the A groups being ethylene groups, and Z represents a hydrogen atom or an OCR″ group in which R″ represents a monovalent group. Preferably, the A groups are ethylene (CH₂CH₂) groups derived for example from ethylene oxide. If it is desired, oxyethylene/oxypropylene copolymers may be used provided that at least 80% of the A groups are ethylene groups. These oxyalkylene polymer chains may have a random or block structure may thus be represented as: Q(OC₂H₄)ₚ(OCH₃C₂H₃)_{q}OZ. The oxyalkylene chain is linked to the silicon atom of the siloxane chain by means of a divalent link Q.

The link may for example be a substituted or unsubstituted, aromatic, alicyclic or aliphatic hydrocarbon, but very conveniently this is an unsubstituted alkylene chain having 2 to about 8 carbon atoms in the chain. If oxyalkylene units other than oxyethylene units are present in the oxyalkylene chain, these may be used to constitute up to 20% of the units of the oxyalkylene chain. Copolymers that can be used are those having an n value of 5 to 25, preferably those having an n value of 5 to 15. Examples of copolymers that can be used, to which reference will be made below have on average about 7.5 or 12 oxyethylene units in each R′ group and have the —(CH₂)₃— group as linking group Q.

The terminal group OZ of the R′ group may be OH or OOCR″, where R″ represents a monovalent group for example a lower alkyl group, for example methyl, ethyl or butyl. Preferred copolymers comprise those in which the terminal group OZ is a hydroxy or acetate group.

Preferred copolymers comprise those of the average general formula Me₃SiO(Me₂SiO)ₓ(MeR′SiO)_{y}SiMe₃, in which Me represents a methyl group. The x/y ratio may be from 1:1 to 11:1 and is preferably from 1:1 to 9:1. Particularly preferably, the x/y ratio is from 3:1 to 7:1 and in particularly from 3:1 to 5:1.

The composition of the invention may include an emulsifier such as PVA (polyvinyl alcohol).

The composition of the invention may also include other compounds normally employed in finish compositions, especially in finish compositions that are used in the field of the spinning of polymers, in particular the spinning of polyamides or polyesters. For example, they may be surfactants, lubricants, etc.

The composition of the invention may include adhesion promoters. Adhesion promoters are known to those skilled in the art specializing in the coating of textiles. Examples of suitable adhesion promoters within the context of the invention are in particular described in patent applications WO 00/60010 and EP 0 681 014.

The composition of the invention preferably comprises at least 50% by weight (solids content) of polyorganosilane.

The composition of the invention is generally in the form of a liquid. This may in particular be a solution, an emulsion or a dispersion in a liquid.

The composition may be in the form of an emulsion, in general an aqueous emulsion. The composition may also be in the form of an oil.

The invention relates, in a second object, to the yarns, fibers or filaments that can be woven without sizing and without washing, having a finish composition as described above which is present at least partly on the surface of the yarns, fibers or filaments.

The yarns, fibers or filaments of the invention may be natural, artificial and/or synthetic. They may also be of several origins: to give an example, a spun yarn of polyamide and cotton fibers may be mentioned.

The yarns, fibers or filaments of the invention are advantageously based on a thermoplastic polymer. As the thermoplastic (co)polymers suitable for the purpose of the invention may be cited by way of example: polyolefins, polyesters, polyalkylene oxides, polyoxyalkylenes, polyhaloalkylenes, poly(alkylene phthalates or terephthalate)s, poly(phenyl or phenylene)s, poly(phenylene oxide or phenylene sulfide), poly(vinyl acetate)s, poly(vinyl alcohols), poly(vinyl halides), polyvinylidene halides, polyvinylnitriles, polyamides, polyimides, polycarbonates, polysiloxanes, acrylic acid or methacrylic acid polymers, polyacrylates or methacrylates, natural polymers such as cellulose and its derivatives, synthetic polymers, such as synthetic elastomers, or thermoplastic copolymers comprising at least one monomer identical to any one of the monomers included in the abovementioned polymers, and also blends and/or alloys of all these (co)polymers.

As other preferred thermoplastic polymers of the invention, mention may be made of semicrystalline or amorphous polyamides, such as aliphatic polyamides, semiaromatic polyamides and, more generally, linear polyamides obtained by polycondensation between an saturated aliphatic or aromatic diacid and an aromatic or saturated aliphatic primary diamine, polyamides obtained by condensation of a lactam or of an amino acid, or linear polyamides obtained by condensation of a mixture of these various monomers.

More precisely, these polyamides may for example be polyhexamethylene adipamide, polyphthalamides obtained from terephthalic and/or isophthalic acid, such as the polyamide sold under the trade name AMODEL, copolyamides obtained from adipic acid, hexamethylenediamine and caprolactam.

The thermoplastic polymer is advantageously a polyester, such as polyethylene terephthalate (PET), polypropylene terephthalate (PPT), polybutylene terephthalate (PBT) and copolymers and blends thereof.

Still more preferably, the thermoplastic polymer is selected from the group of (co)polyamides comprising: polyamide-6, polyamide-6,6, polyamide-4, polyamide-11, polyamide-12, polyamides 4-6, 6-10, 6-12, 6-36, 12-12 and copolymers and blends thereof.

The yarns, fibers and filaments of the invention may be based on a blend of thermoplastic polymers or thermoplastic copolymers.

The yarns, fibers and filaments of the invention may include additives, such as reinforcing fillers, flame retardants, UV stabilizers, heat stabilizers, mattifying agents such as titanium dioxide, bioactive agents, etc.

The finish composition advantageously represents 0.05 to 5% by weight (solids content), preferably 0.1 to 2%, relative to the weight of the yarn.

The overall linear density of the yarns of the invention may be chosen within the entire range of usual yarn linear densities, for example between 10 dtex and 2500 dtex, advantageously between 10 and 1100 dtex. Within the field of airbags, the overall linear density is advantageously between 100 and 950 dtex.

The linear density of the filaments of the yarns of the invention may be chosen from the full range of normal yarn linear densities. The linear density of the filaments is generally greater than or equal to 0.3 dtex. It is usually less than the dtex equivalent of a diameter of 800 microns in the case of large-diameter monofilaments. In the case of airbags, the yarns are generally multifilament yarns and the linear density of the filaments is advantageously between 1.5 and 7 dtex.

According to one particular embodiment of the yarns, fibers or filaments of the invention, the composition on the surface of the yarns, fibers or filaments of the invention is not crosslinked.

The invention also relates to a process for producing a yarn, fiber or filament comprising the following steps:
1) spinning the constituent material of the yarn;
2) optionally, drawing the yarn;
3) optionally, texturing the yarn; and
4) treating the yarn using the composition as defined above.

The spinning step 1) is carried out using any method known to those skilled in the art.

When the material of the yarn is a thermoplastic polymer, step 1) is advantageously a step in which the polymer undergoes melt spinning.

The yarns, fibers or filaments of the invention may undergo drawing. Thus, the yarn may be drawn along the spinning path using any known process, to the desired draw ratio depending on the orientation and the mechanical properties that it is desired to give it. It may also be simply preoriented or oriented during spinning, depending on the final wind-up speed. It may be obtained directly or subsequently on rolls so as to regulate the wind-up tension, should this prove to be useful or necessary. Step 2) may be carried out integrally or non-integrally with the spinning.

The winding speed is generally between 100 and 8000 m/min, advantageously between 600 and 5000 m/min and preferably between 700 and 4000 m/min.

The texture in step 3) may be carried out using any method known to those skilled in the art.

The treatment step 4) may be carried out before or after the optional drawing step. The treatment step 4) may also be carried out before or after the optional texturing step 3). The composition for the treatment of step 4) is, as indicated above, generally in the form of a liquid. It may in particular be an oil, a solution, an emulsion or a dispersion in a liquid. Advantageously, the composition is in the form of an emulsion, preferably an aqueous emulsion.

In the case of a multifilament yarn, the treatment enables the mutual cohesion of the filaments to be improved.

The treatment of step 4) may be carried out using the normal techniques, such as deposition using rollers or slotted nozzles. Among the usual techniques, mention may be made of, as nonlimiting examples, the technique of treating the raw fiber using a roll, by spraying or vaporization, by soaking, by the technique of pad-finishing, and also any method used in the textile industry for the treatment of synthetic fibers. Advantageously, the treatment is carried out with the help of slotted nozzles. This treatment may be performed at various steps in the manufacture of the yarns. These are, among others, all the steps in which finishes are conventionally added. Thus, the additive may be applied at the bottom of the spinner before wind-up. It is also possible, in the case of “fiber” processes, to apply the additive before, during or after the drawing, crimping or drying steps, etc.

In certain cases, it may also be advantageous for the yarn to undergo a first beforehand treatment (a pretreatment) using methods known to those skilled in the art, so as to promote the adhesion of the composition to the yarn. Furthermore, it may also be envisioned to subject the yarn, before or after the treatment of step 4), to other chemical or physical treatments such as, for example, irradiation, dyeing and the like.

According to one particular embodiment of the process of the invention, the composition deposited on the yarns, fibers or filaments does not crosslink during the step of producing the yarns, fibers or filaments.

The invention also relates, according to a third object, to a woven or knitted fabric comprising, at least in part, yarns, fibers or filaments as described above, and also to a process for obtaining this woven or knitted fabric. The yarns used to produce the woven or knitted fabric may be of the same or different type. The yarns of the invention constitute at least the warp of the fabric, advantageously they constitute both the warp and the weft of the fabric.

The yarns of the invention may be used for example as warp yarns on industrial weaving looms. Advantageously, they make it possible to produce a woven fabric without a sizing step. Preferably, they make it possible to produce a woven fabric with neither a sizing step nor a washing step.

The yarns of the invention, when they are used as warp yarns, may be easily employed either in direct warping or sectional warping without the need for sizing and may be woven on all types of looms, in particular on high-speed looms used in industry.

In certain cases, for example when the yarn is intended to be woven on looms causing high stresses on the warp yarns, it may be preferable to wax the yarns with any product normally used before the weaving is carried out.

Advantageously, the woven fabrics comprising the yarns of the invention are obtained using a dry loom, such an air jet loom, a rapier loom or a projectile loom.

The fabric of the invention advantageously has a weight per unit area of 40 to 400 g/m². The fabric, in particular in the airbag field, generally has a number of yarns per cm of fabric between 10 and 30.

The yarns, fibers, filaments and woven and knitted fabrics of the invention are particularly useful in the field of airbags, which constitutes the fourth object of the invention. The yarns may be used for the production of woven or knitted fabrics for airbags. These woven or knitted fabrics are advantageously produced without a sizing step, and preferably without a washing step, thereby simplifying the method of obtaining such articles and reducing its cost. The yarns, fibers, filaments and woven and knitted fabrics of the invention are particularly useful for the production of woven or knitted airbag fabrics having a protective coating, in particular a silicone protective coating.

In addition, these fabrics may also be produced without a heat treatment step. A heat treatment step is effectively carried out on fabrics with the purpose of giving them dimensional stability. This heat treatment step is generally carried out simultaneously with the step of drying the fabric, which drying step is needed when a washing step has been carried out on the fabric. Within the context of the present invention, when the washing step is omitted, the drying step is no longer necessary. Reheat treatment step may thus be carried out simultaneously with a subsequent step of the process, in particular in the case of the use of the woven or knitted airbag fabric. For example, it may be carried out after the woven or knitted fabric is coated with the elastomer and advantageously it is carried out simultaneously with the elastomer crosslinking step.

The presence of the composition on the surface of the yarns, fibers and filaments has no influence on the subsequent treatments that the woven or knitted fabric may undergo, especially when the woven or knitted fabric is used in the field of airbags. As an example of such subsequent treatments, there may be mentioned coating with an elastomer, etc. In particular, the fire and temperature resistance properties and the abrasion and scrubbing properties are not altered.

The composition according to the invention, present on the surface of the yarns, fibers and filaments used for example for the preparation of a woven or knitted airbag fabric does not constitute the optional protecting elastomer coating of the woven or knitted fabric.

Finally, the invention relates, in a fifth object, a woven or knitted airbag fabric constituted at least partially of yarns, fibers or filaments having a composition comprising a polyorganosiloxane at least partly present on the surface of these yarns, fibers or filaments. The composition present on the surface of the yarns is not the optional protecting elastomer coating of the fabric. All that has been described above relating to the finish composition of the invention, in particular the form of the composition, the solids content and its application to the yarn, applies in the same way to the composition comprising the polyorganosiloxane. Likewise, all that has been described above relating to the description of the yarns, fibers and filaments, and especially the nature of the polymer, the linear density etc., applies here in the same way in respect of the fifth object of the invention.

The woven or knitted airbag fabric constituting the fifth object of the invention advantageously includes a protecting coating, preferably made of silicone. It may be obtained by weaving on a loom yarns, fibers or filaments having a composition that includes a polyorganosiloxane present on at least part of the surface of these yarns, fibers or filaments, or by knitting them. All that has been described above relating to the weaving or knitting process applies here in the same way. The presence of the polyorganosiloxane on the surface of the yarns, fibers or filaments, which is generally introduced during the sizing of the yarns, advantageously allows weaving without sizing and preferably weaving with neither sizing nor a washing step, and does not alter the required final properties of the airbag fabric, namely in particular the fire and temperature resistance and scrubbing and abrasion resistance (scrub test) properties.

Advantageously, the finishing composition for the woven or knitted fabric of the fifth object of the invention comprises at least 50% by weight (solids contents) of polyorganosiloxane.

Further details or advantages of the invention will become more clearly apparent in the light of the examples given below solely by way of illustration.

Production of Fabrics for their Evaluation

Various finishing compositions were evaluated. To simulate a fabric finished with each of these products, undyed fabrics normally used in the fabrication of airbags were used. The finish of the undyed fabric was removed beforehand and then heat treated under the conditions normally used by those skilled in the art, namely by washing it at 60° C. in the presence of a detergent followed by thermosetting at 180° C. for 30 s. The residual finish content after the finish removal is normally less than 0.1%.

The following fabric was used: a polyamide-6,6 cloth produced from yarns of 700 dtex/104 filaments sold under the reference T 682 by Rhodia IY. The cloth comprised 16 to 17 yarns/cm both in the warp and the weft directions. Its weight after washing and setting was about 255 g/m².

The evaluation procedure was the following:
two specimens of (20×28 cm²) format are cut out;
they are soaked for 2 min in a dilute aqueous emulsion of the finish to be tested, the dilution used depending on the type of finish and on the amount of product that it is desired to deposit;
the specimens are then removed and then suspended vertically using two clamps in a hood for a few minutes and then heat-treated for 2 minutes in a ventilated oven at 200° C. One of the specimens will be used to measure the amount of finish by extraction using petroleum ether or dichloromethane. The other will be coated. By extraction the mean amount of a specimen (solids content relative to the weight of fabric) is determined;
the specimen to be coated is weighed;
it is then coated using a laboratory doctor blade with the silicone resin sold under the reference RHODORSIL® TCS 7510 A and B by Rhodia Silicones. The amount deposited is about 40±10 g/m² (solids content);
the coated fabric is weighed so as to calculate the amount deposited;
the specimen is then heat treated for 80 seconds in an oven at 180° C.;
it is then removed from the oven and left in the ambient air; and
a 5×10 cm² specimen is cut out and then evaluated in the scrub test or heat resistance test.

### Scrub Test: Determination of the Scrub Resistance (According to the ISO 5981 Standard)

This test allows to characterize the scrubbing and abrasion resistance of a coated fabric.

It consists in subjecting the fabric, on the one hand, to a shear movement using two jaws gripping the two opposed edges of a sample and undergoing an alternating movement one with respect to the other, and on the other hand to an abrasion by contact with a moving support.

### Flame Resistance Test (According to the ISO 3795 Standard)

This test is used to evaluate the flame resistance of the fabric when the airbag is inflated by a hot gas.

A 138 mm×64 mm sample is cut out. Reference marks are produced so as thereafter to measure the propagation time.

This sample is positioned horizontally, a Bunsen burner is used to burn it for 15 s, and then the Bunsen burner is removed. The flame propagation time between the reference marks is then measured, thereby enabling the propagation speed to be calculated.

Preferably, the product must be self-extinguishable, i.e. the flame must not propagate.

Generally, three successive tests are carried out on each specimen.

### EXAMPLES

Various finish compositions were evaluated, using the protocol described above.

The various compounds of the finish composition used are the following:
A: SILCOLEASE® crosslinking emulsion 966 sold by Rhodia Silicones (polydimethylmethylhydrogenosiloxane) with a viscosity of 220 mPa;
B: SILCOLEASE® resin 11367 sold by Rhodia Silicones (polymethylvinylsiloxane) with a viscosity of 200 mPa;
C: SILCOLEASE® emulsion 902 sold by Rhodia Silicones (nonionic aqueous emulsion of polydimethylmethylhodrogenosiloxane and polymethylvinyl siloxane) with a viscosity of 120 mPa;
D: RHODORSIL® TCS 7110 A sold by Rhodia Silicones polydimethylmethylhodrogenosiloxane and polymethylvinyl siloxane); and
E: RHODORSIL® SP3301 sold by Rhodia Silicones (nonhydrolysable silicone/polyether copolymer).

The nature and the proportions of the compositions tested together with the results of the tests are described in the table below.

TABLE

| | Solids | Nature of the | Finish | Result of | Result of |
|---|---|---|---|---|---|
| | content of | solids content | content | the scrub test | the heat |
| | the finish | of the finish | (solids | (number of | resistance |
| Examples | composition | composition | content) | rubbings) | test |
| 1 | 2.5 | A 100% | 1.25 | >2000 | Self- |
| | | | | | extinguishing |
| 2 | 1.2 | A 100% | 0.7 | >2000 | Self- |
| | | | | | extinguishing |
| 3 | 0.6 | A 100% | 0.4 | >2000 | Self- |
| | | | | | extinguishing |
| 4 | 2.5 | B 100% | 1.1 | >2000 | |
| 5 | 2.5 | C 100% | 1.4 | >2000 | |
| 6 | 2.5 | D 100% | 1.3 | 400 | |
| 7 | 2.5 | A/E (90/10 | 1.0 | >2000 | Self- |
| | | by weight) | | | extinguishing |
| 8 | 1.2 | A/E (90/10 | 0.7 | >2000 | Self- |
| | | by weight) | | | extinguishing |
| 9 | 5 | C/E (90/10 | 2.2 | 200 | Self- |
| | | by weight) | | | extinguishing |
| 10 | 2.5 | C/E (90/10 | 1.1 | 200 | Self- |
| | | by weight) | | | extinguishing |
| 11 | 1.25 | C/E (90/10 | 0.6 | 400 | Self- |
| | | by weight) | | | extinguishing |
| 12 | 2.5 | D/E (90/10 | 1.05 | 200 | Self- |
| | | by weight) | | | extinguishing |
| 13 | 10 | B/E (90/10 | 3.6 | 400 | Self- |
| | | by weight) | | | extinguishing |
| 14 | 10 | B/E (90/10 | About 1 | | |
| | | by weight) | | | |
| 15 | 10 | C/E (95/5 | About 1 | | |
| | | by weight) | | | |
| 16 | 30 | C/E (93/7 | 0.8 | | |
| | | by weight) | | | |

The fabrics after coating obtained according to Examples 1 to 13 are dimensionally stable.

The finish compositions of examples 14 and 15 were used in a polyamide-6,6 spinning process described below:

The polyamide-6,6 used was a postcondensed polyamide-6,6 containing 0.02% titanium oxide, having a relative viscosity of 2.95 (measured at a concentration of 10 g/l in 96% sulfuric acid) after postcondensation, and having a moisture content of about 0.03% before use.

This polymer is introduced into and melted by a twin-screw extruder. It is then melt-spun so as to obtain a continuous yarn of 235 dtex comprising 34 filaments. After extrusion, the filaments are cooled in air and then brought together at two guides for depositing the finish. The yarn thus obtained is wound up at 200 m/min. The main conditions are given below:
extrusion temperature: 293.5° C.
temperature of the spinning pack: 288° C.;
winding time: 1 h;
operation: no breaks or faults.

The yarn is hot-drawn in one step by passing it through an oven, and then relaxed before being wound onto a cop.

The yarn thus obtained has the following characteristics (measured according to the DIN 53834 standard):
tenacity: 68 cN/tex;
elongation at break: 25%.

Although not having been interlaced, this yarn exhibits a good cohesion. Such a yarn analyzed using an apparatus of the ROTHSCHILD type has a level equivalent to an interlacement of 3 to 4 N/m, i.e. equivalent to that of a conventional yarn obtained with an emulsion of a conventional finish. These nodes are very stable.

To check its capability of being used in weaving, it was introduced as weft yarn on a conventional airbag yarn warp, mounted on a rapier loom. 5 m of fabric were thus produced without stoppage.

The finish composition of Example 16 was used in the polyamide-6,6 spinning process describe below:

The polyamide-6,6 used was a postcondensed polyamide-6,6 containing 0.02% titanium oxide and having a relative viscosity of 3.25 (measured at a 10 g/l concentration in 96% sulfuric acid).

This polymer is introduced into and melted by an extruder. It is then melt-spun so as to obtain a continuous 470 dtex yarn containing 68 filaments using an integrated spinning/drawing process. After extrusion the filaments are cooled in air and then passed over a guide for depositing the finish. They are then gathered together.

The finish composition is deposited in the form of an emulsion. The yarn is then taken up at 650 m/min and then hot-drawn in two steps with a draw ratio of 4.5, relaxed and then interlaced before winding up at 2900 m/min.

The yarn thus obtained has the following characteristics (according to the DIN 53834 standard):
toughening: 82.5 cN/tex;
elongation at break: 21.5%;
Shrinkage in hot air at 180° C.: 6.8%;
interlacement: 16 nodes/m.

A fabric is then produced from these yarns, using a rapier loom. The warping and spinning are satisfactory. After coating the fabric according to the process described above, the result of the scrub test (in number of rubbings) is equal to 1500 on average.

1-33. (canceled)

34. A finish composition for yarns, fibers or filaments, comprising a compound A, compound B or both, the compound A being a monomer, an oligomer and/or a polymer containing at least one Si—H structural unit and the compound B being a monomer, an oligomer a polymer containing at least one unsaturated aliphatic group.

35. The composition according to claim 34, wherein compound A is a polyorganosiloxane.

36. The composition according to claim 35, wherein the polyorganosiloxane A is a polyorganohydrogenosiloxane comprising:
units of the formula:
$${H}_{a} {W}_{b} {SiO}_{\frac{4 - ( a + b )}{2}} \qquad ( 1 )$$
in which:
the symbols W are the same and/or different and are selected from
a linear or branched alkyl residue containing 1 to 18 carbon atoms, optionally substituted with at least one halogen atom;
a cycloalkyl residue containing 5 to 8 ring carbon atoms, optionally substituted with at least one halogen atom;
an aryl residue containing 6 to 12 carbon atoms which may optionally be substituted on the aryl part with at least one halogen atom, alkyl and/or alkoxyl group containing 1 to 3 carbon atoms; and
an arylalkyl part having an alkyl part containing 5 to 14 carbon atoms and an aryl part containing 6 to 12 carbon atoms, optionally substituted on the aryl part by at least one halogen atom, alkyl and/or alkoxyl group containing 1 to 3 carbon atoms; a is 1 or 2, b is 0, 1 or 2, with the sum (a+b) having a value of 1 to 3; and
optionally, other units of average formula (2):
$$Wc {SiO}_{ \frac{4 - c}{2}} \qquad ( 2 )$$
in which W has the same meaning as above and c has a value of 0 to 3.

37. The composition according to claim 35, wherein the polyorganosilane A is selected from the group consisting of:
polydimethylsiloxanes having hydrogenodimethylsilyl and groups:
polydimethylhydrogenomethylsiloxanes having trimethylsilyl end groups;
polydimethylhydrogenomethylsiloxanes having hydrogenodimethylsilyl end groups;
polyhydrogenomethylsiloxanes having trimethylsilyl end groups; and
cyclic polyhydrogenomethylsiloxanes.

38. The composition according to claim 34, wherein compound B is a polyorganosiloxane.

39. The composition according to claim 38, wherein the polyorganosiloxane B is chosen from polyorganosiloxanes comprising equal or different units of formula (3):
$${W}_{d }^{′} {Y}_{e} {SiO}_{\frac{4 - ( d + e )}{2}} \qquad ( 3 )$$
in which:
the symbols W′, which are the same or different, are selected from the group consisting of:
a linear or branched alkyl residue containing 1 to 18 carbon atoms, optionally substituted with at least one halogen atom;
a cycloalkyl residue containing 5 to 8 ring carbon atoms, optionally substituted with at least one halogen atom;
an aryl residue containing 6 to 12 carbon atoms which may optionally be substituted on the aryl part with at least one halogen atom, an alkyl group and/or alkoxyl group containing 1 to 3 carbon atoms; and
an arylalkyl part having an alkyl part containing 5 to 14 carbon atoms and an aryl part containing 6 to 12 carbon atoms, optionally substituted on the aryl part by at least one halogen atom, an alkyl group and/or alkoxy group containing 1 to 3 carbon atoms;
the symbols Y are equal or different and represent C₁-C₁₂ linear or branched alkenyl residue having at least one ethylenic unsaturation at the chain end and/or in the chain, and optionally at least one heteroatom;
e is equal to 1 or 2, d is equal to 0, 1 or 2 with the sum (d+e) having a value of 1 to 3; and
optionally, other units of average formula (2′):
$${W}^{′} c {SiO}_{\frac{4 - c}{2}} \qquad ( {2}^{′} )$$
in which W′ has the same meaning as above and c has a value of 0 to 3.

40. The composition according to claim 34, comprising at least 50% by weight (solids content) of polyorganosiloxane.

41. The composition according to claim 34, that does not contain a polyaddition catalyst.

42. A yarn, fiber or filament that can be woven without sizing, comprising a composition according to claim 34 on at least part of the surface of the yarns, fibers or filaments.

43. The yarn, fiber or filament according to claim 42, comprising a thermoplastic polymer.

44. The yarn, fiber or filament according to claim 42, comprising a polyester or polyamide.

45. The yarn, fiber, or filament according to claim 42 wherein the composition represents 0.05 to 5% weight relative to the weight of the yarn, fiber or filament.

46. The yarn, fiber or filament according to claim 45, wherein the composition represents 0.1 to 2% by weight relative to the weight of the yarn, fiber or filament.

47. The yarn, fiber or filament according to claim 42, wherein the overall linear density of the yarn, fiber or filament is between 100 and 950 dtex.

48. The yarn, fiber or filament according to claim 42, wherein the linear density of the filaments is between 1.5 and 7 dtex.

49. A process for producing a yarn, fiber or filament according to claim 42, comprising the steps of:
1) spinning material to prepare a constituent material of the yarn, fiber or filament;
2) optionally, drawing the yarn, fiber or filament;
3) optionally, texturing the yarn, fiber or filament; and
4) treating the yarn, fiber or filament using the composition of claim 34.

50. The process according to claim 49, wherein the constituent material is a thermoplastic polymer and the spinning is melt-spinning of the polymer.

51. The process according to claim 49 wherein step 4) is carried out after steps 2) and 3).

52. The process according to claim 49 wherein step 4) is carried out before steps 2) and 3).

53. A woven or knitted fabric, comprising at least in part yarns, fibers or filaments of claim 42.

54. A woven or knitted fabric comprising yarns, fibers, or filaments prepared by the process of claim 49.

55. A process for the production of a warp and weft fabric or of a knit comprising weaving or knitting, respectively, of yarns, fibers or filaments obtained by the process of claim 49.

56. A process for the production of a warp and weft fabric or of a knit comprising weaving or knitting, respectively, of yarns, fibers or filaments of claim 42.

57. The process according to claim 55, that does not include a sizing step.

58. The process according to claim 56, that does not include a sizing step.

59. The process according to claim 53, that does not include a step of washing the woven or knitted fabric.

60. The process according to claim 54, that does not include a step of washing the woven or knitted fabric.

61. The process according to claim 55, wherein weaving is carried out using a loom.

62. The process according to claim 56, wherein weaving is carried out using a loom.

63. The process according to claim 61, wherein the loom is a dry loom.

64. The process according to claim 62, wherein the loom is a dry loom.

65. The process according to claim 63, wherein the loom is an air jet loom, a rapier loom or a projectile loom.

66. The process according to claim 64, wherein the loom is an air jet loom, a rapier loom or a projectile loom.

67. An airbag comprising yarn, fiber or filament according to claim 42.

68. A woven or knitted airbag fabric constituted at least partially of yarns, fibers or filaments having a composition comprising a polyorganosiloxane present on at least a part of the surface of the yarns, fibers or filaments, the composition being other than an optional silicone protecting coating on the woven or knitted fabric.

69. The woven or knitted airbag fabric according to claim 68, wherein the fabric includes a protective coating.

70. The woven or knitted airbag fabric according to claim 69, wherein the protective coating is a silicone coating.

71. The woven or knitted airbag fabric according to one of claim 68, wherein the composition comprises at least 50% by weight of polyorganosiloxane.

72. A process for producing a warp and weft fabric or knit according to claim 68, comprising weaving, or knitting of yarns, fibers or filaments having a composition comprising a polyorganosiloxane present on at least a part of the surface of the yarns, fibers or filaments.

73. The process according to claim 72, that does not include a sizing step.

74. The process according to claim 72, that does not include a step of washing the woven or knitted fabric.

75. The process according to claim 72, that does not include a step of heat treating the woven or knitted fabric.
